(19) United States
(12) Patent Application Publication
(10) Pub. No.: US 2011/0235339 A1
(43) Pub. Date: Sep. 29, 2011

(54) Molded Fluorescence Plastic Lens and Manufacturing Method Thereof

(76) Inventors: San-Woei Shyu, Taipei (TW); Chien-Yi Huang, Taipei (TW); Ching-Wei Sun, Taipei (TW); Wen-Huang Liu, Taipei (TW)

(21) Appl. No.: 12/205,370

(22) Filed: Sep. 5, 2008

(30) Foreign Application Priority Data
Dec. 20, 2007 (TW) 096149013

(51) Int. Cl. F21V 5/04; B29D 11/00

(52) U.S. Cl. 362/326; 264/1.7

(57) ABSTRACT

A molded fluorescent plastic lens and a manufacturing method thereof are disclosed. The fluorescent material 3 is attached on surface of plastic preform or a cavity of a mold core of a mold. By plastic molding, the plastic preform is heated, pressured and cast into a molded fluorescent plastic lens with a fluorescent surface. Thus the molded fluorescent plastic lens not only has shape and optical properties of the molded forming lens, but also has fluorescent properties from a fluorescent surface layer formed by fluorescent material inserted into the plastic. Thus the produced molded fluorescent plastic lens is applied to road reflectors, white light LED or other optical elements for use.

### BACKGROUND OF THE INVENTION

The present invention relates to a molded fluorescent plastic lens and a manufacturing method thereof, especially to a plastic lens with a fluorescent surface made from fluorescent material and plastic preform by plastic molding technique and a manufacturing method thereof.

A fluorescent plastic lens is a plastic lens with fluorescent properties that has been broadly applied to white LED (light emitting diode) or optical elements. Refer to JP2007-116124, JP2006-156704, JP 2004-363343, JP 2007-180111, US7,029,935, US2002/125494, US2004/070001 and Taiwan Pat No. M263624 etc., light emitted from LED chip passes the lens with fluorescent properties to excite fluorescence and generate white light and the devices are called wavelength-converting elements. They can be made from plastic or glass. As shown in U.S. Pat. No.6,887,011, road surface light reflectors with fluorescent color are disclosed. The wavelength-converting elements made from plastic are fluorescent plastic lens that has been applied to various industries.

Nowadays the components of white light LED available includes Red, Green and Blue (RGB) chips, blue LED with wavelength-converting elements having yellow phosphors, UV LED with wavelength-converting elements having RGB Phosphors, or phosphor powder such as ZnSe. There are various structure and manufacturing methods of the fluorescence plastic lens, such as: (1) mixing the phosphor particles with plastic material is processed by injection forming, as disclosed in TW M263624, TW200404880, US 2007/228587, U.S. Pat. No. 5,718,849, U.S. Pat. No. 4,514,357, JP2007-090660, JP2007-123417, JP2000-286455 etc. Refer to FIG. 3. An alternative method is the phosphors 3 are evenly mixed into plastic material to form a preform 8 that is treated by plastic molding to generate a fluorescent plastic lens 2. The plastic lens has not only certain shape, optical properties and fluorescent properties of the molded lens, but also with light weight and low cost, so that the lens are broadly used in the field of white-light LED. (2) Adding the phosphors or other materials into a film then presses or sprays on the surface of plastic lens, as revealed in JP 10-301514, JP 2006-261540, JP 2004-071908, US2007/194691, US2007/096140, US2003/102481, U.S. Pat. No. 7,071,616, etc. Refer to FIG. 1, a plastic lens 2 is produced by injection molding or plastic molding. Then a fluorescent film 5 is pressed (or attached) on the plastic lens 2. (3) Refer to FIG. 2, a further way is to powder fluorescent materials on a plastic lens and to cover a transparent layer 6 on the plastic lens. Wherein, the plastic lens 2 maybe produce by injection molding or plastic molding, as shown in JP2006-100730, JP2004-088009, U.S. Pat. No.5,962,971, U.S. Pat. No. 6,506,506 etc..

In order to make the plastic lens with preset shape or optical properties (surfaces), the most common technique being used is plastic molding. A plastic block or plastic preform with similar bastard of the product is put into an upper mold and a lower mold and then being heated until the plastic is soft. Then casts the plastic by closing-up the molds. After cooling a period of time, the molded plastic lens is released by separation of the upper mold and the lower mold, as shown in TW 573740, TW316869, US2007/160745, U.S. Pat. No. 4,975,328, US2005/104244, JP2006-002044, JP2007-154173, JP2000-256377, JP2007-142281 etc. The plastic preform can be plastic balls, uncertain shape with equivalent weight to the product, or plastic preform with similar shape of the product. Moreover, extrusion compression molding is one of plastic molding techniques. A melt plastic is extruded into the upper and the lower mold by an extruder and then run a casting process, as shown in TW224115, U.S. Pat. No. 6,042,754, US2007/0228587, US2007/0160745, JP10-060248, JP2002-283399, JP2002-347092, etc. Due to broad applications of the fluorescent plastic lens and fast, conveniently processes of the plastic production, there is a need to develop a fluorescent plastic lens with simple structure made by the plastic molding or injection molding so that not only complicated processes of mixing phosphors into plastic material or phosphors in a sandwich structure can be avoid. Therefore, the manufacturing efficiency is improved, the cost is reduced and the progress of industries is enhanced.

### SUMMARY OF THE INVENTION

Therefore it is a primary object of the present invention to provide a molded fluorescent plastic lens that features on preset shapes and optical properties, a fluorescent surface with fluorescent properties so that the molded fluorescent plastic lens is applied to LED, optical elements with other applications, roadside reflectors or reflectors on signs. Thus the shortcomings of conventional plastic lens with fluorescent material used on LED such as limited shapes and difficulties in producing complicated optical surfaces are overcome.

It is another object of the present invention to provide a manufacturing method of molded fluorescent plastic lenses that attaches phosphor material on surface of a plastic preform or preset area on a cavity of a mold core. Then by plastic molding equipment and technique, the plastic preform and the mold core are pressed and heated for casting. While pressing the plastic preform, the phosphor material is inserted into surface of the soft plastic preform. By such simplified manufacturing processes, automatic manufacturing is facilitated and the cost is reduced.

Furthermore, the plastic preform used can be a ball, disc, cube, other shape or plastic preform through molding with shape similar to the product. Because there is no restriction on shape, characters of the plastic material, design of the mold core, and design of the lens, the manufacturing method of the present invention is more flexible and more convenient for producers.

In addition, the way of attaching phosphor material depends on producers and can be done by hand-painting, powder dispersion, air spray gun or by electrostatic coating that makes the coating be more even and fast. There are various coating ways for producers to choose and this is more convenient for users. As to the fluorescent material being used, it should be durable under high temperature processes such as plastic molding and can be organic or inorganic. For example, in applications of the LED, YAG phosphor, TAG phosphor or nitride Phosphor is used. Because the fluorescent material has similar function as the releaser, the plastic lens will not adhere to the mold core. The method of the present invention is called Phosphor powder Inserted Plastic Surface (PIPS) technique.

### BRIEF DESCRIPTION OF THE DRAWINGS

FIG. 1 to FIG. 3 are schematic drawings showing fluorescent plastic lenses manufactured by conventional technique;

FIG. 4A is an embodiment of a molded fluorescent plastic lenses according to the present invention;

FIG. 4A′ is a partial enlarged view of the embodiment in FIG. 4A;

FIG. 4B is another embodiment of a molded fluorescent plastic lenses with red fluorescent material (represented by ∘), yellow fluorescent material (represented by X), and blue fluorescent material (represented by Δ) according to the present invention;

FIG. 4 B′ is a partial enlarged view of the embodiment in FIG. 4B;

FIG. 5 is a schematic drawing showing the attaching of fluorescent material by a powder dispenser;

FIG. 6 is a schematic drawing showing the attaching of fluorescent material by a brush;

FIG. 7 is a schematic drawing showing the attaching of fluorescent material by an electrostatic coating device;

FIG. 8 is a schematic drawing showing manufacturing process of a plastic preform without certain shape according to the present invention;

FIG. 9 is a schematic drawing showing extrusion compression molding process of a plastic preform according to the present invention;

FIG. 10 is a schematic drawing showing temperature and pressure being used during molding process according to the present invention;

FIG. 11 is a schematic drawing showing temperature and pressure being used during extrusion compression molding process according to the present invention.

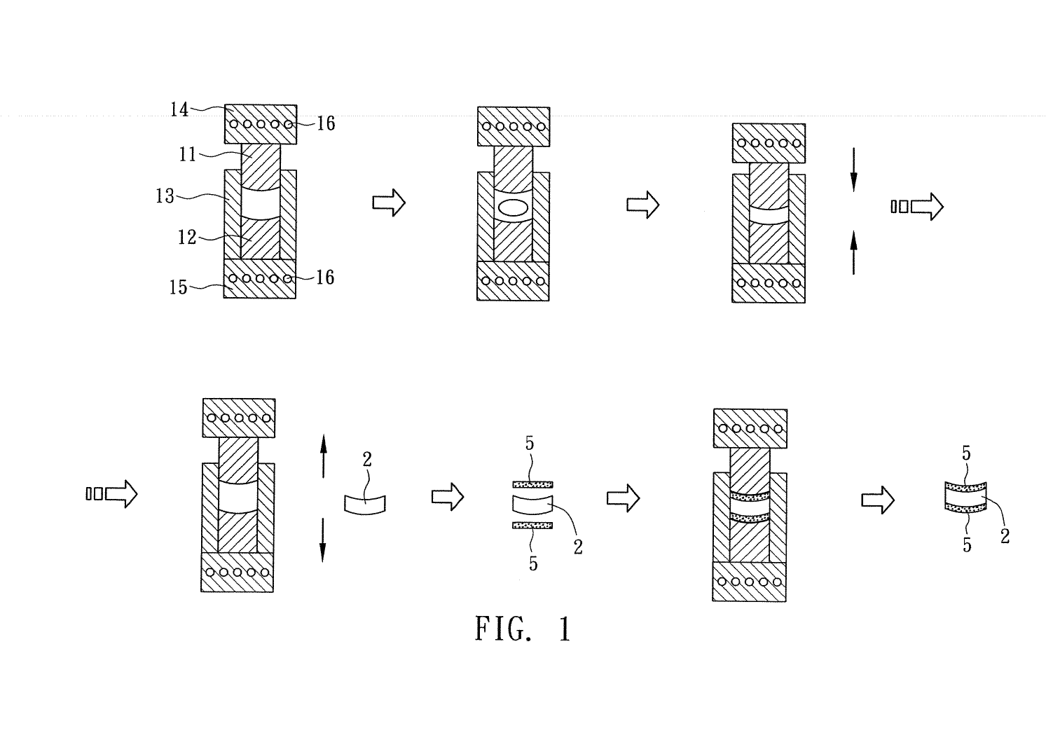

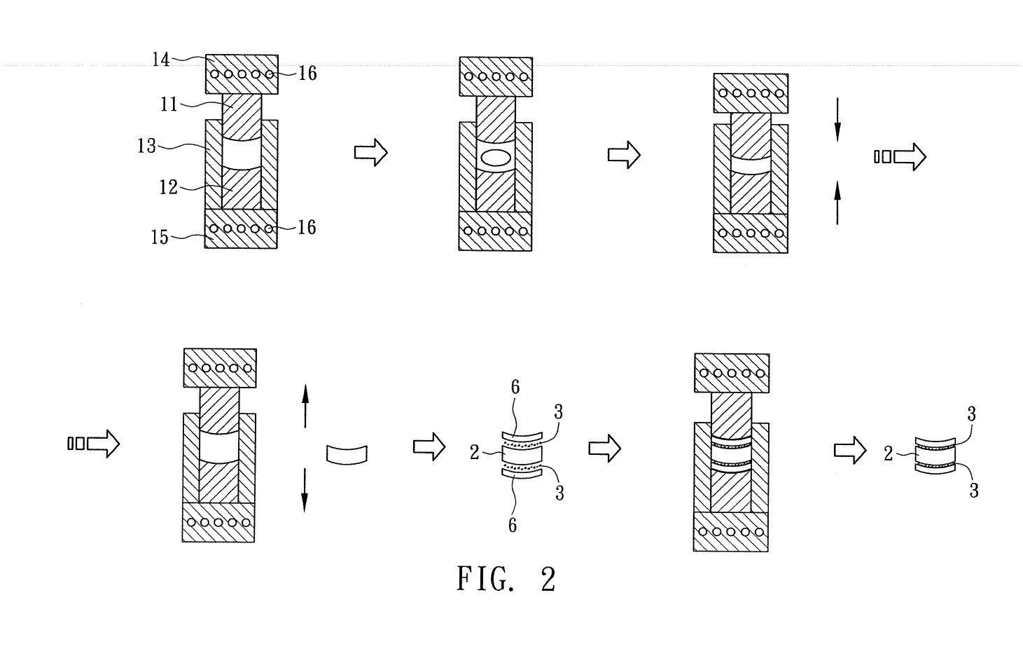

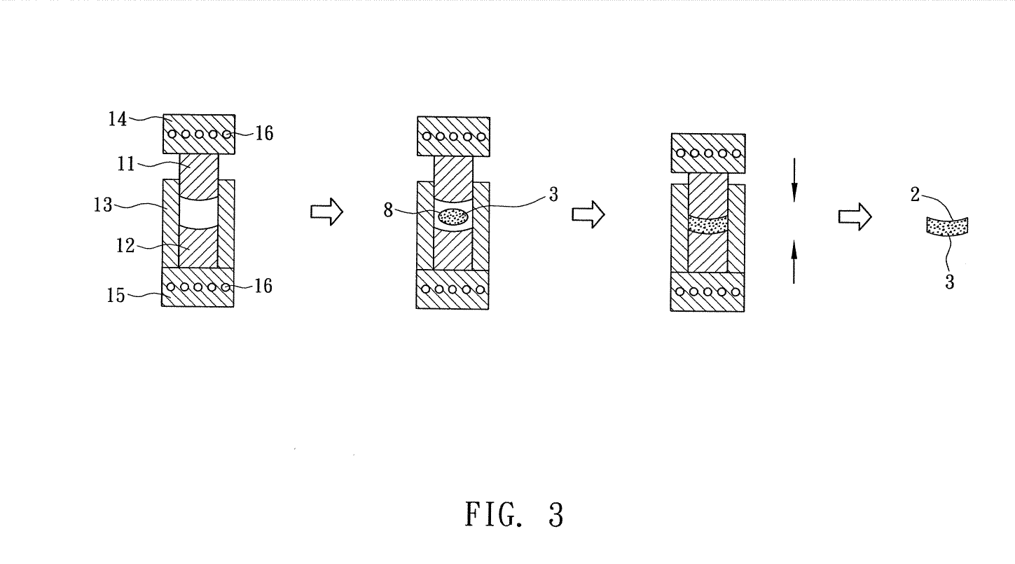

### DETAILED DESCRIPTION OF THE PREFERRED EMBODIMENT

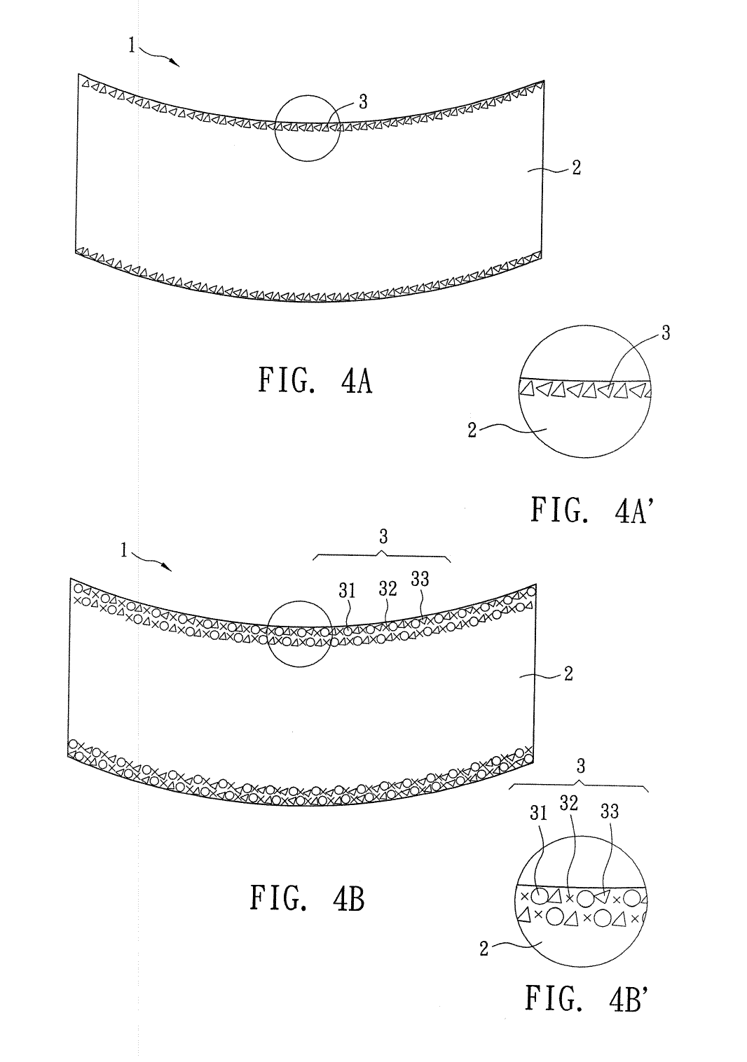

Refer to FIG. 4A & FIG. 4A′, a molded fluorescent plastic lens 1 according to the present invention includes a plastic lens 2 with preset lens shape and a fluorescent material 3 inserted into surface of the plastic lens 2 by plastic molding. The molded fluorescent plastic lens 1 features on that the fluorescent material 3 is inserted into surface of the plastic lens 2 by the plastic molding method so that the plastic lens 2 has preset lens shape, optical properties(surfaces) and fluorescent properties. There is no limit on plastic material of the plastic lens 2 and the fluorescent material 3. The plastic lens 2 is made from polyc arbonate(PC), COC(cyclic olefin copolymer), polymethyl methacrylate (PMMA) or COP. When being applied to wavelength-converting elements of LED, the fluorescent plastic lens 1 is made from plastic with higher light transmittance, high Abbe number, and high heat resistance.

The first embodiment

Refer to FIG. 4A & FIG. 4A′, a molded fluorescent plastic lens 1 of this embodiment is applied to the white-light LED. After being excited, blue light from the GaN LED passes the molded fluorescent plastic lens 1 and converts to the white-light through wavelength conversion. The plastic lens 2 of the molded fluorescent plastic lens 1 is made mainly from polycarbonate(PC) while the fluorescent material 3 is yttrium-aluminum-garnet (YAG) phosphor containing Cerium (Ce) and terbium (Tb). The plastic molding is a molding process run under the to perature over the plastic softening point. The plastic material of the plastic lens 2 has became soft so that the YAG phosphor of the fluorescent material 3 is pressed and inserted into surface of the soft plastic lens 2 by the mold core so as to form the lens 1 of the present invention.

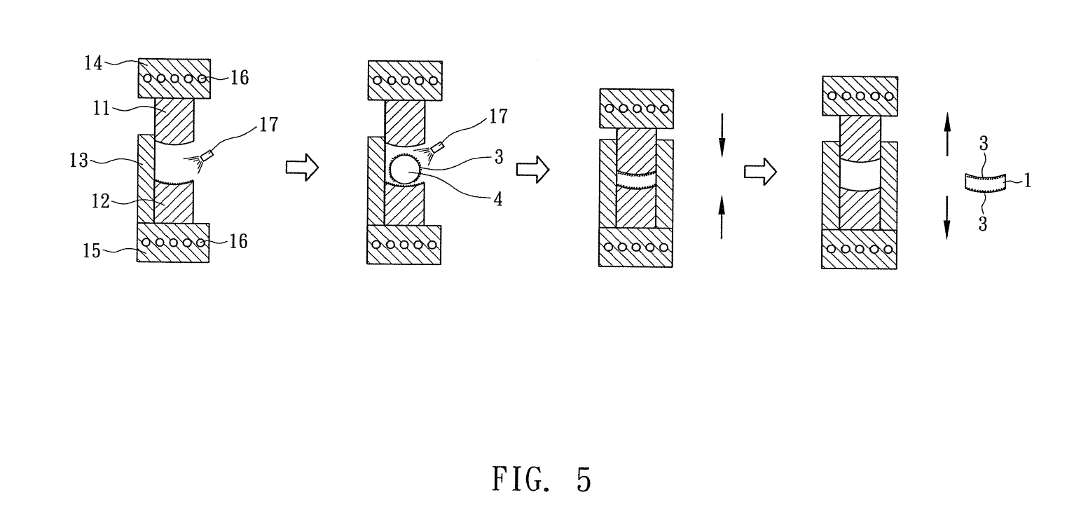

The manufacturing processes of the lens 1 according to the present invention are shown in FIG. 5, a plastic preform 4 is set into an upper mold core and a lower mold core 11, 12 and then attach the fluorescent material 3 on the upper mold core and/or the lower mold core 11, 12 or the plastic preform 4 by painting or spraying. Heat the molds until the temperature is over the plastic softening point. Then run a molding process that close-up the upper mold core and the lower mold core 11, 12. After being cooled a preset time, the upper mold core and the lower mold core 11, 12 are separated from each other to release the molded fluorescent plastic lens 1. There is no restriction on coating ways or shapes of the plastic preform 4. Moreover, the fluorescent material 3 can use terbium-aluminum garnet(TAG) phosphor that is garnet phosphor containing Cerium(Ce), terbium(Tb) , Yttrium (Y) , Gadolinlium (Gd) , and Lanthanum (La) etc. The Nitride Phosphor formed by Group II A metal or rare earth metal elements sintering in nitrogen can also be used.

The second embodiment

Refer to FIG. 4B & FIG. 4B′, the fluorescent material 3 is a mixture of red fluorescent material, yellow fluorescent material, and blue fluorescent material. After plastic molding processes, a molded fluorescent plastic lens 1 with the fluorescent material 3 having red, yellow and blue fluorescent surface is produced. The molded fluorescent plastic lens 1 is applied to white-light LED or UV-LED. After being excited, the UV light from the UV-LED emits onto fluorescent surface having red, yellow and blue colors of the fluorescent plastic lens 1 so as to generate white light. As to the (inorganic) fluorescent material 3 having red, yellow and blue colors used in this embodiment, the yellow fluorescent material 32 is YAG phosphor, TAG phosphor or nitride phosphor; the red (inorganic) fluorescent material 31 consists of Y₂O₃ (Yttrium Oxide and) and Eu₂O₃ (Europium Oxide); the blue (inorganic) fluorescent material 33 is ZnS sintered compound added with silver (Ag) and chloride (Cl).

The followings are five embodiments of a manufacturing method of the molded fluorescent plastic lens 1 according to the present invention.

The first embodiment

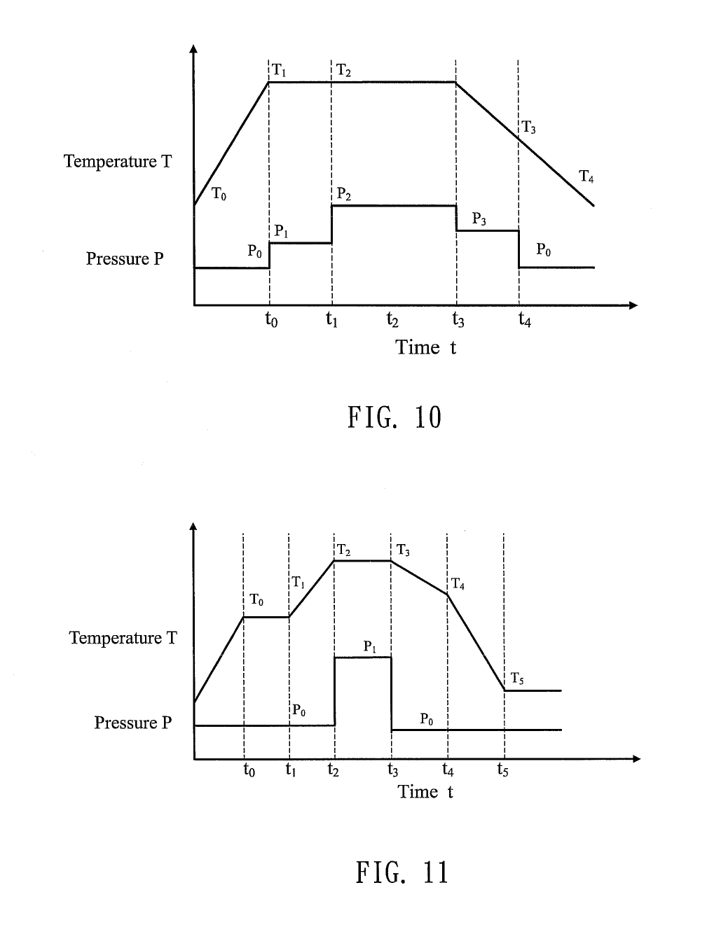

The manufacturing method of the molded fluorescent plastic lens can be manufactured by using cast molding. Refer to FIG. 5, the first step is to prepare a plastic preform 4. Then use a powder dispenser 17 to attach the fluorescent material 3 on surface of a cavity of a lower mold core 12. Put the plastic preform 4 into the cavity of the lower mold core 12. Next use powder dispenser 17 to spray the fluorescent material 3 onto surface of the plastic preform 4. Heat the upper and the lower mold cores 11, 12 until the temperature is over a softening temperature Tp of the plastic preform 4. In this embodiment, the temperature is 30° C. higher than Tp of PMMA and that's 115° C. Then increase the pressure ranging from 1 to 20 MPa (in this embodiment is 12 MPa) so as to make the plastic preform 4 soften. Now pressure the upper and the lower mold core 11, 12 with higher pressure ranging from 1 to 20 MPa (in this embodiment is 18 MPa) so that the upper mold core 11 moves downwards within a mold shaper 13 due to pressure from an upper mold base 14 while the lower mold core 12 moves upwards within the mold shaper 13 due to pressure from an lower mold base 15. Thus the fluorescent material 3 is pressured and inserted into surface of the plastic preform 4 and the softened plastic preform 4 is cast into a plastic lens with preset shape and optical properties (surfaces) by the upper and the lower mold core 11, 12. The relationship of the temperature and the pressure used in this embodiment is shown in FIG. 10. Next cool the upper and the lower mold cores 11, 12 until the temperature is lower than the softening temperature Tp generally ranging from 80° C. to 50° C. (in this embodiment is 55° C.). and also reduce the pressure to lower pressure ranging from 0.1 MPa to 5 MPa (in this embodiment is 4.7 MPa) for a period of time so as to separate the upper and the lower mold cores 11, 12. Finally, release the molded fluorescent plastic lens 1 from the lower old core 12.

The second embodiment

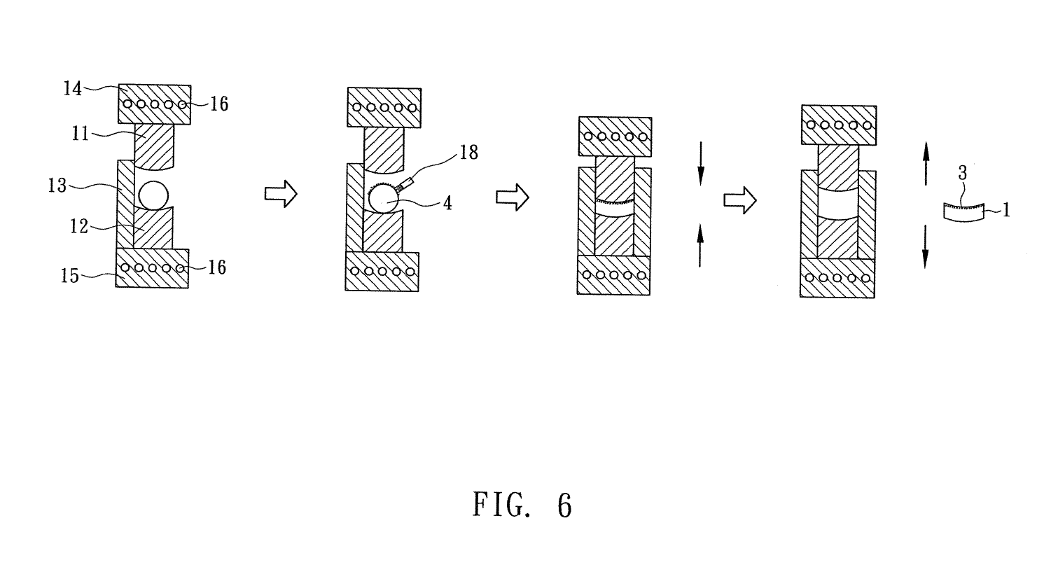

Refer to FIG. 6, firstly, prepare a plastic preform 4. In this embodiment, COC is used. Then put the plastic preform 4 into a cavity of a lower mold core 12 and use a brush 18 to attach the fluorescent material 3 onto a preset area whose width is about 3 mm on surface of the plastic preform 4. Next heat the upper and the lower mold cores 11, 12 until the temperature is over 30° C. than the plastic softening temperature Tp so as to make the plastic preform 4 become soft. In this embodiment, the Tp of COC is 128° C. . Increase the preset pressure (in this embodiment is 16 MPa) on the upper and the lower mold cores 11, 12 so that the fluorescent material 3 is pressured and inserted into surface of the plastic preform 4 and the soft plastic preform 4 is cast by the mold cores 11, 12 into a plastic lens with preset shape and optical surfaces. Then cool the upper and the lower mold cores 11, 12 down to the te perature that is lower than the plastic softening temperature, about 76° C. Reduce the pressure to separate the upper and the lower mold cores 11, 12 and release the molded fluorescent plastic lens 1 having a fluorescent layer with width of 3 mm on a single optical surface. While being applied to LED, the lens 1 emits blue light with white light having width of 3 mm.

The third embodiment

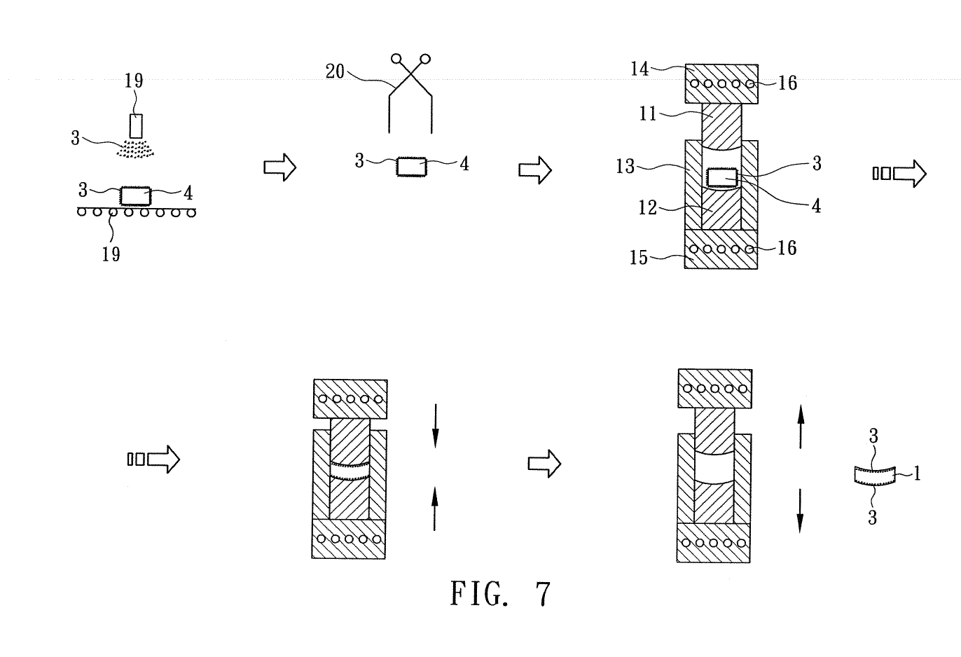

Refer to FIG. 7, in the beginning, prepare a plastic preform 4 made from PMMA by injection molding and with similar shape and weight to the final product. Then use an electrostatic coating device 19 to attach the fluorescent material 3 onto the plastic preform 4. Next put the plastic preform 4 into a cavity of the lower mold core 12 by a clam 20 and heat the upper and the lower mold cores 11, 12 until the temperature is over the plastic softening temperature Tp so that plastic preform 4 becomes soft. Increase the pressure on the upper and the lower mold cores 11, 12 so that the fluorescent material 3 is pressured and inserted into surface of the plastic preform 4 and the soft plastic preform 4 is cast by the mold cores 11, 12 into a plastic lens with preset shape and optical surfaces. Then cool the upper and the lower mold cores 11, 12 down to the temperature lower than the plastic softening temperature Tp. Reduce the pressure to separates the upper and the lower mold cores for releasing the molded fluorescent plastic lens 1 from the lower mold core 12. The electrostatic coating device 19 is used to attach the fluorescent material 3 onto the plastic preform 4 in a off line way in advance and then the plastic preform 4 is put into the mold for molding. Thus the fluorescent material 3 is evenly distributed onto the plastic preform 4 and the automatic equipments are used so that yield and productivity are increased. Moreover, the plastic preform 4 has similar shape and weight of the final product so that there is no residual plastic material flowed out during molding processes, the molding period is reduced, and deformation during cooling is less. Thus the lens has precise shape and optical surfaces.

In this embodiment, the temperature and the pressure control curves are shown in FIG. 10. Under normal pressure P₀, the plastic preform 4 is set into the cavity of the lower mold core 12 attached with the fluorescent material 3 and then increase the temperature from room temperature T₀ to T₁ , about T₁=Tp+30=150° C. Now apply the preset pressure P₁=5 MPa for a period of time until the time t₁. Then increase the pressure intoP₂=18 MPa. Until the end of time of t₃, reduce the pressure to P₃=10 MPa. At the time of t₄, cool down the temperature to T₃. Also at the time of t₄, the pressure is reduced to normal pressure and the temperature is cooled down to the mold opening temperature T₄. Release the final product.

The fourth embodiment

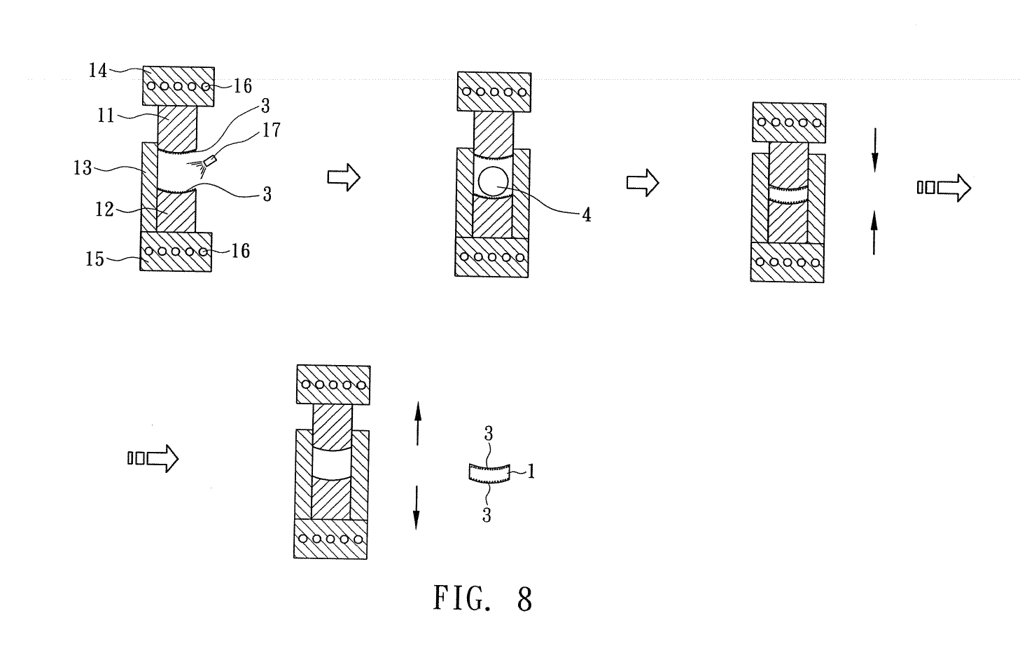

Refer to FIG. 8, prepare a plastic preform 4 without certain shapes. Then use a powder dispenser 17 to attach the fluorescent material 3 on surface of a cavity of the upper and the lower mold cores 11, 12. Next put the plastic preform 4 into the cavity of the lower mold core 12. The same processes as the third embodiment, heat and pressure the mold cores for molding and then reduce temperature and pressure to produce the molded fluorescent plastic lens 1.

The fifth embodiment

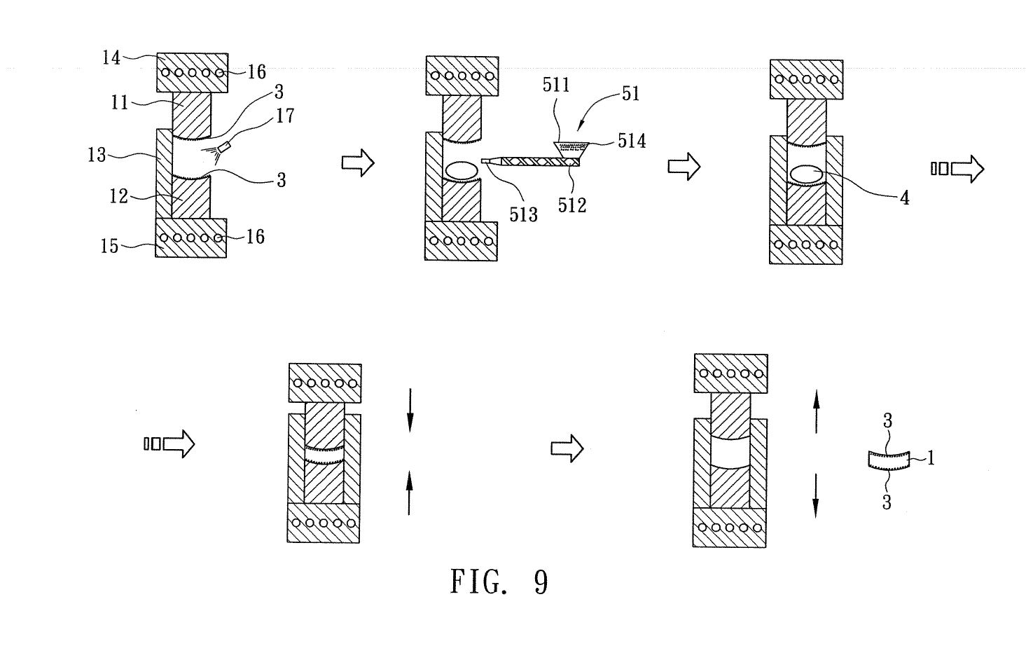

The manufacturing method of the molded fluorescent plastic lens can be manufactured by using extrusion molding also. Refer to FIG. 9, prepare COC plastic material 514 and put it into a barrel 511 of an injection machine 51 and heat the plastic material until it becomes soft. Then use a powder dispenser 17 to attach the fluorescent material 3 on surface of a cavity of the upper and the lower mold cores 11, 12. Extrude the plastic material 514 in the feeder through a pipe 512 and a nozzle 513 into the cavity between the upper and the lower mold cores 11, 12 to form a plastic preform 4. Heat and pressure the upper and the lower old cores 11, 12 so that the fluorescent material 3 is pressured and inserted into surface of the plastic preform 4 and the softened plastic preform 4 is extruded into a plastic lens with preset shape and optical surfaces by the upper and the pressure and the cavity of the lower old core 11, 12. Cool down the upper and the lower mold core 11, 12 until the temperature is lower than the softening point of the plastic Separate the upper and the lower mold core 11, 12 to release the produced fluorescent plastic lens 1.

In this embodiment, the temperature and the pressure control curves are shown in FIG. 11. Under normal pressure P₀, the upper and the lower mold cores 11, 12 is heated to the temperature T₀ in advance and attach the fluorescent material 3 first. Then extrude COC plastic material 514 into the cavity and the temperature increases to T₂ at this moment. Next increase the pressure to P₁=18 MPa. At the time of t₃, reduce the pressure to normal pressure P₀ and starts to cool down. At the time of t₄, reduce the temperature in a first kind of slope to the T₄ while T₄=85° C. . At the time of t₅, reduce the temperature in another kind of slope to the T₅ while T₅=45° C. . After the time of t₅, open the mold for releasing the final product.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is :

1. A molded fluorescent plastic lens comprising a plastic lens with preset shape and optical properties; and a fluorescent layer on surface of the plastic lens formed by fluorescent material inserted into surface of the plastic lens through a plastic molding process.

2. The molded fluorescent plastic lens as claimed in claim 1, wherein the lens is formed by the plastic molding process and having preset shape and optical properties while the fluorescent layer is formed by attaching the fluorescent material on a plastic preform or a cavity of a mold core of a mold and the fluorescent material is inserted into surface of the lens during heating and pressuring of the plastic molding process.

3. The molded fluorescent plastic lens as claimed in claim 1, wherein the fluorescent material is AG phosphor, TAG phosphor or nitride phosphor.

4. The molded fluorescent plastic lens as claimed in claim 1, wherein the fluorescent material is a single phosphor or combinations of phosphors.

5. The molded fluorescent plastic lens as claimed in claim 4, wherein the fluorescent material is a mixture of red fluorescent material, yellow fluorescent material, and blue fluorescent material.

6. The molded fluorescent plastic lens as claimed in claim 1, wherein the fluorescent layer is covered on whole surface area or a specific area of surface of the lens.

7. A manufacturing method of a molded fluorescent plastic lens
comprising the steps of:
preparing a plastic preform;
attaching fluorescent material on a preset surface area of the plastic preform;
putting the plastic preform attached with the fluorescent material into a cavity of an upper mold core and a lower mold core of a mold;
heating the upper mold core and the lower mold core until temperature is over the softening temperature of the plastic preform and the plastic preform becomes soft; then pressuring the upper mold core and the lower mold core so that the fluorescent material is inserted into surface of the plastic preform and the plastic preform is molded into a plastic lens with preset shape by the upper mold core and the lower mold core;
cooling the upper mold core and the lower mold core, and reducing the pressure for separating the upper mold core and the lower mold core; and
releasing a molded fluorescent plastic lens.

8. A manufacturing method of a molded fluorescent plastic lens
comprising the steps of:
preparing a plastic preform;
attaching fluorescent material on a preset surface area of an upper mold and/or a lower mold of a plastic molded forming equipment;
putting the plastic preform attached with the fluorescent material into a cavity of the upper mold core and the lower mold core of the plastic molded forming equipment;
heating the upper mold core and the lower mold core until temperature is over the softening temperature of the plastic preform and the plastic preform becomes soft; then pressuring the upper mold core and the lower mold core so that the fluorescent material is inserted into surface of the plastic preform and the plastic preform is molded into a plastic lens with preset shape by the upper mold core and the lower mold core;
cooling the upper mold core and the lower mold core, and reducing the pressure for separating the upper mold core and the lower mold core; and
releasing a molded fluorescent plastic lens.

9. A manufacturing method of a molded fluorescent plastic lens
comprising the steps of: preparing plastic material and heat the plastic material in an injection machine;
attaching fluorescent material on a preset surface area of an upper mold and/or a lower mold of a plastic molded forming equipment;
extruding the plastic material into a cavity of the upper mold core and the lower mold core of the plastic molded forming equipment by the injection machine;
heating the upper mold core and the lower mold core to a preset temperature and then increasing the pressure so that the fluorescent material is inserted into surface of the plastic preform and the plastic preform is molded into a plastic lens with preset shape by the upper mold core and the lower mold core;
cooling the upper mold core and the lower mold core, and reducing the pressure for separating the upper mold core and the lower mold core; and
releasing a molded fluorescent plastic lens.

10. The method as claimed in claim 7, wherein the fluorescent material in the step of attaching fluorescent material on a preset surface area of the plastic preform is attached on the preset surface area by hand painting.

11. The method as claimed in claim 8, wherein the fluorescent material in the step of attaching fluorescent material on a preset surface area of the plastic preform is attached on the preset surface area by hand painting.

12. The method as claimed in claim 9, wherein the fluorescent material in the step of attaching fluorescent material on a preset surface area of the plastic preform is attached on the preset surface area by hand painting.

13. The method as claimed in claim 7, wherein the fluorescent material in the step of attaching fluorescent material on a preset surface area of the plastic preform is attached on the preset surface area by a powder dispenser.

14. The method as claimed in claim 13, wherein the powder dispenser for coating the fluorescent material is disposed with an electrostatic coating device.
